(19) United States
(12) Patent Application Publication
(10) Pub. No.: US 2001/0025826 A1
(43) Pub. Date: Oct. 4, 2001

(54) Dense-plasma etching of InP-based materials using chlorine and nitrogen

(76) Inventors: Thomas E. Pierson, Evanston, IL (US); Christopher T. Youtsey, Farmington Hills, MI (US); Seng-Tiong Ho, Wheeling, IL (US); Seoijin Park, Lawrenceville, NJ (US)

Correspondence Address: Steven B. Pokotilow, Esq., Stroock & Stroock & Lavan, LLP, 180 Maiden Lane, New York, NY, 10038, US

(21) Appl. No.: 09/795,715

(22) Filed: Feb. 28, 2001

Related U.S. Application Data
(60) Provisional application No. 60/185,308, filed on Feb. 28, 2000.

(51) Int. Cl. C23F 1/00; B44C 1/22

(52) U.S. Cl. 216/55; 216/67; 216/75; 438/710

(57) ABSTRACT

A semiconductor dry etching process that provides deep, smooth, and vertical etching of InP-based materials using a chlorinated plasma with the addition of nitrogen (N₂) gas. Etching of InP-based semiconductors using an appropriate Cl₂/N₂ mixture without any additional gases provides improved surface morphology, anisotropy and etch rates.

### CROSS-REFERENCE TO RELATED APPLICATIONS

This application claims priority to Provisional Patent Application Serial No. 60/185,308, filed on Feb. 28, 2000.

### DEVELOPMENT

The present invention was developed, at least in part, under grant F49620-96-1-0262, provided by DARPA. The United States Government has certain rights in this invention.

### FIELD OF THE INVENTION

The present invention is directed to an improved method of etching III-V semiconductors.

### BACKGROUND OF THE INVENTION

In the fabrication of nano-scale semiconductor structures, etching is critical. For nano-scale opto-electric and optical devices, surface morphology (i.e., smoothness or lack thereof) determines, at least in part, the performance characteristics of the device; smoother surfaces minimizing optical scattering losses and improving the optical performance of the device. High selectivity (i.e., the difference in etch rate between the substrate and the masking material (how deep a semiconductor may be etched without also etching away the mask)), minimal undercut (i.e., anisotropic etching or verticality), and high throughput (etch rate) may all be achieved with high-density-plasma etching, a technique in which an electric field causes energetic ions to strike the surface of a semiconductor substrate at an angle perpendicular to the substrate surface.

Unfortunately, etching processes that produce desired characteristics (i.e., surface smoothness, verticality, etc.) for certain types of semiconductors do not necessarily produce desired characteristics for all or different semiconductors. Thus, well known and relatively mature etching processes used to etch silicon (Si) or gallium arsenide (GaAs), for example, do not yield the same results when used to etch indium phosphide (InP). This is because different semiconductors necessitate different etching chemistries to react with the substrate atoms and are thus subject to different processing issues. For example, difficulties arise in obtaining smooth-etched surfaces in InP-based semiconductors using chlorine-based chemistry etching due to the differing volatilities in the InClₓ and the PClₓ and their corresponding different removal rates during etching. Consequently, an etched surface may be either In-rich or P-rich and thus exhibit rough surface morphology. One solution has been to use methane/hydrogen chemistries, which have been shown to produce relatively smooth InP surfaces, but at very slow etch rates, e.g., approximately 100 nm/minute. Also, CH₄/H₂ processes lead to the deposition of polymers that can adversely alter the chamber conditions and thus affect process reproducibility.

Diluting Cl₂ with inert gases has been proposed to reduce Cl neutral radical density. Using N₂ as a dilute gas showed excellent effect on reaction chemistry in the etching of In-based compound semiconductors. The combination of Cl₂/N₂ for ECR etching has also been disclosed. See, e.g., S. Miyakuni, R. Hattori, K. Sato, H. Takano, and O. Ishihara, “Low ion energy electron cyclotron resonance etching of InP using a Cl₂,/N2 mixture,” Journal of Applied Phys. 78(9), 5734-5738, November 1995.)

Various chemistries have been proposed to provide smoother etched surfaces in InP-based semiconductors. For example, in addition to Cl₂/N₂/Ar mixture, Cl₂/CH₄/N₂/H₂, Cl₂/CH₄/N₂, Cl₂/N₂/H₂, Cl₂/O₂/N₂ and Cl₂/N₂/Ar mixtures have been investigated. While O₂ has been used for increasing the oxide mask selectivity, adding O₂ in Cl₂/N₂ mixture decreases the etch rates. For example, adding 1 sccm O₂ into 4.2 sccm Cl₂ and 10 sccm N₂ decreases etch rate by half. Adding CH₄ results in reducing undercut and improves bottom surface smoothness, but CH₄ usually makes polymers. At high temperature, the deposited polymers on the sidewall is strong enough to passivate the sidewall so that lateral etching is reduced (i.e., sidewall roughness is increased by the polymer deposition). Another problem is that the mask selectivity is reduced, which shows that polymerization does not occur on the mask surface. Adding Ar increases etch rates, but degrades surface smoothness.

Dry etching of semiconductors may be performed using various known processes such as, for example, Inductively Coupled Plasma-Reactive Ion Etching (ICP-RIE), Electron Cyclotron Resonance-Reactive Ion Etching (ECR-RIE), and Chemically Assisted Ion Beam Etching (CAIBE), to name a few.

Inductively Coupled Plasma-Reactive Ion Etching (ICP-RIE) is a dry etching process especially well suited for etching III-V semiconductors. The ICP-RIE process provides for precise feature etching by chemical reaction, as opposed to by direct bombardment (i.e., by force). The ICP-RIE process utilizes a gas plasma having a predetermined chemistry to cause a chemical reaction between the plasma gas and semiconductor being etched. The ICP-RIE process also uses inductive coupling to direct the plasma gas at the semiconductor.

Electron cyclotron resonance reactive ion etching (ECR-RIE) is used to process III-V semiconductors (e.g., InP, GaAs, InGaAsP). This dry etching technique has certain characteristics that make it preferable to wet etching, such as: anisotropic etching with high fidelity pattern transfer, the ability to obtain vertical, smooth sidewalls, and etch rates that are independent of crystalline orientation.

CAIBE is a technique used to etch patterns into a substrate material in a very controllable, high fidelity fashion. CAIBE provides the ability to etch vertical or angled sidewalls with mirror-like smoothness. This has been exploited in the field of photonics to make integrated lasers, mirrors and diffraction gratings which generate, route and diffract light on the surface of semiconductor chips.

The CAIBE process combines the action of a broad area, collimated ion beam and a reactive gas to remove material from a substrate in areas which are not protected by a patterned masking material. The etching process occurs under conditions in which the substrate does not spontaneously etch when exposed to the reactive gas, but does etch when the ion beam is also present—leading to the alternative name “ion beam assisted etching” (IBAE). The ion beam by itself will etch the surface by physical sputtering. This process, also known as “ion milling”, is caused by atoms being knocked off the surface by the impact of the incident ions. The addition of the reactive gas in CAIBE greatly increases the substrate material removal rate for a given ion beam flux.

The characteristics of CAIBE are due to its mixing of “physical” and “chemical” attributes. The ions in the collimated beam travel in nearly parallel paths, so the etching proceeds in a “line-of-sight” fashion in the unmasked areas of the substrate. Control of the etching angle can be achieved by tilting the sample with respect to the beam direction. The etching rate and profile can be made insensitive to crystal orientation and alloy composition. The reactive gas adds the benefit of reducing the number of incident ions required to achieve a desired etching depth. This reduces both the amount of ion-induced crystal damage, and undesirable trenching and redeposition effects associated with physical sputtering. Use of the reactive gas also allows one to choose a masking material which does not react with the gas. Deep etches can be made with relatively thin masking layers and little degradation of the mask pattern.

For many years, people have been studying CAIBE, mostly for GaAs. Improved verticality is obtained by combining bottom surface activation by energetic inert gas ions, a reactive gas and mask erosion. To make ions bombard only on the bottom surface, a high quality collimating beam is necessary. The beam divergence is determined by many factors such as hole size, grid distance, accelerated voltage, beam voltage and beam-current density. With a fixed grid, the beam divergence is mainly controlled by interaction of beam voltage and accelerated voltage. Typically, higher accelerated voltage increases the beam divergence. With a fixed beam divergence, the way to make ions bombard on the substrate vertically is increasing the distance between the grid and the substrate. As the distance increases, the chance that the ions deviating from normal direction bombard on the substrate is decreased. With a fixed distance, the way to reduce the beam deviation is reduce the amount of reactive gas. The reactive gas makes the beam deviation increase by collision. With keeping reaction balance, to reduce the amount of reactive gas, it is necessary to design the gas feeding system in a efficient way; for which a gas nozzle may be installed close to the substrate. With a fixed feeding system, the important etch parameters to obtain a vertical etch profile are temperature and the lateral erosion property of the mask. By increasing the temperature, the reactivity (etch rate) increases, and the amount of a reactive gas required may be decreased, resulting in improved beam directionality. However, side etching becomes more vulnerable. If all effects are compromised, an optimum temperature range may be determined for a vertical etch profile. In the case of GaAs etching, a temperature range of 100-120° C. is widely used. For InP etching, a higher temperature range of 215-250° C. due to the reaction balance may be used.

In InP etching, Ar ion beam and Cl₂ reactive gas are used as in GaAs etching. However, the same etching chemistry is not applicable to the different semiconductors. Typically, for InP etching, increasing the temperature has been the only way to obtain smoother surfaces. However, using high temperatures may cause more side etching by the mask erosion, even when reducing reactive gas and collision. It has been determined that surface smoothness (i.e., morphology) may be improved by diluting the reaction. For example, if reactive species, like neutral radicals, are dense in the process chemistry, InClₓ is deposited on the substrate. Consequently, InClₓ does not experience complete desorption on the substrate, and another InClₓ is made. The non-desorption InClₓ deposits react with each other and act as micro-masking, thereby increasing surface roughness.

### SUMMARY OF THE INVENTION

The present invention is directed to a semiconductor dry etching process that provides deep, smooth, and vertical etching of InP-based materials using a chlorinated plasma with the addition of nitrogen (N₂) gas. In accordance with embodiments of the present invention, etching of InP-based semiconductors using an appropriate Cl₂/N₂ mixture without any additional gases provides improved surface morphology, anisotropy and etch rates. The present invention is directed to a novel etching process and chemistry that is based on balancing desorption rates by the control of the volatility of PCIₓ in contrary to the conventional way that the balance of the desorption rates is controlled by the volatility of InClₓ. The inventive process provides an improved dry etching process (e.g., ICP-RIE, ECR-RIE, or CAIBE) for InP-based semiconductor materials that yields significantly improved surface smoothness (i.e., morphology), vertically, and etch rates of up to 800 nm per minute (depending upon the process).

The addition of N₂ gas dilutes reactive Cl₂ gases and promotes sidewall passivation. It is believed that InNₓ products are formed during etching and deposited on the sidewalls, thereby preventing lateral attack of the semiconductor material. To produce relatively high anisotropy with exceptionally smooth surfaces, the amount of nitrogen gas added is approximately greater than the volumetric measure of chlorinated gas in standard cubic centimeter per minute (sccm); at a ratio of at least than 1:1 (depending upon the dry etch process). Argon (Ar) may also be added to further dilute the chlorine chemistry and to server as a more effective sputtering agent. However, the deep, smooth and vertical surfaces provided by the present invention may be achieved without the addition of Ar.

In illustrative embodiments of the present invention, the proposed mixture of N₂ and Cl₂ are provided in ICP-RIE, ECR-RIE, and CAIBE processes. Control of various other process parameters also provides increased control over surface morphology, anisotropy and etch rates.

In an embodiment of the present invention, nitrogen is added to a chlorinated (i.e., Cl₂-based, BCL₃-based, SiCL₄-based, etc.) dry-etch process. The added nitrogen dilutes the Cl₂ gas thereby reducing Cl neutral radical density. For improved smoothness, verticality and etch rates, the amount of nitrogen gas added must exceed the volumetric measure of chlorinated gas in sccm. Preferably, the flow rate ratio of nitrogen gas to chlorinated gas is at least 1:1.

The invention accordingly comprises the features of construction, combination of elements, and arrangement of parts which will be exemplified in the disclosure herein, and the scope of the invention will be indicated in the claims.

### BRIEF DESCRIPTION OF THE DRAWINGS

In the drawing figures, which are not to scale, and which are merely illustrative, and wherein like reference characters denote similar elements throughout the several views:

FIG. 1 is a schematic diagram of an ICP-RIE system;

FIG. 2 is a schematic diagram of an ECR-RIE system;

FIG. 3 is a schematic diagram of a CAIBE system;

FIG. 4 is a Scanning Electron Microscope (SEM) image of an annular disc etched using a ECR-RIE system in accordance with an embodiment of the present invention;

FIG. 5 is a SEM image of an annular disc and two waveguides etched using an ICP-RIE system in accordance with an embodiment of the present invention;

FIG. 6 is a SEM image of a waveguide slab etched using an ICP-RIE system in accordance with an embodiment of the present invention;

FIGS. 7A and 7B are SEM images of a directional coupler etched using different ratios of Cl₂/N₂, depicting the improved etching characteristics obtained with an increase in the ratio of N₂ to Cl₂;

FIG. 8 is a table of parameters for ECR-RIE, CAIBE and ICP-RIE processes in accordance with embodiments of the present invention; and

FIG. 9 is a SEM image of a InP/InGaAsP lithographic alignment marks ICP-RIE etched 4-mm-deep at a rate of 800 nm/min in accordance with the present invention.

### DETAILED DESCRIPTION OF THE PRESENTLY PREFERRED EMBODIMENTS

The present invention is directed to a semiconductor dry etching process that provides deep, smooth, and vertical etching of InP-based materials by the introduction of an appropriate amount of N₂, and with proper control of various other etching parameters for ICP-RIE, ECR-RIE and CAIBE processes. To produce high anisotropy with exceptionally smooth surfaces, and to increase etch rates, the amount of nitrogen gas added is preferably at least equal to the volumetric measure of chlorinated gas in standard cubic centimeter per minute (sccm); a ratio of at least 1:1.

Applicants have discovered an etching process for InP-based materials where the addition of nitrogen gas in predetermined amounts or ratios to chlorinated gas can provide improved anisotropy with exceptionally smooth, vertical surfaces (i.e., sidewalls), and etch rates. Thus, InP-based optical devices may be made with high throughput using the present invention, and will exhibit improved optical properties due to the exceptionally smooth vertical surfaces.

For ICP-RIE processing, the range for nitrogen is approximately 5 to 50 sccm, and for chlorine, approximately 5 to 10 sccm. Argon may be added (but need not be to yield the benefits and advantages of the present invention) ranging from approximately 5 to 20 sccm. For ECR-RIE processing, nitrogen may be added to the process at a rate ranging from approximately 10 to 20 sccm, corresponding to a rate for chlorine ranging from approximately 3 to 10 sccm. For CAIBE processing, the range for nitrogen is approximately 0 to 10 sccm, and for chlorine, approximately 5 to 20 sccm. Argon may be added (but need not be to yield the benefits and advantages of the present invention) ranging from approximately 2 to 10 sccm.

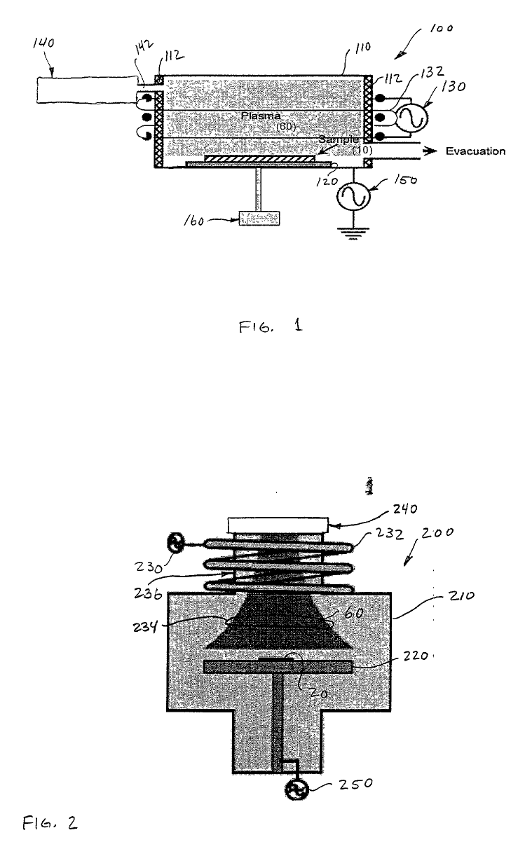

The present invention may be carried out using any of a ICP-RIE system, ECR-RIE system, or CAIBE system. As the present invention is not directed to any components or construction of those systems, but rather, in providing desired chemistries for etching processes carried out using those systems, a detailed discussion of those systems and the various component parts thereof is not considered necessary to enable a person of skill in the art to practice the present invention. Each of an ICP-RIE, ECR-RIE, and CAIBE system will now be generally discussed. A general representation of an ICP-RIE system is depicted in FIG. 1 and generally designated as reference numeral 100. The system 100 includes an etching chamber 110 having a platen 120 or other similar structure upon which a sample 10 may be selectively placed and removed (typically using loadlocks, robotics, and the like). A plasma source 140 (which may comprise one or a plurality of mass flow controllers (MFCs)) if fluidly coupled to the chamber 110 by a feed conduit 142, and provides a plasma gas input to the chamber 110. The plasma gas may be accelerated into the chamber 110 by a first power source 130 into the chamber 110. A coil 132 wound about the chamber 110 may be provided and coupled to the first power source 130. A second power source 160 may be provided and connected to the platen 120, to provide voltage bias control within the system 100.

The first power source 130 (e.g., a 2 MHz RF generator) may be used to generate a plasma discharge 60 in the chamber 110 by applying power into an inductive coil 132. The first power source 130 may also be used to control the plasma density and ion flux (i.e., number of incident ions per unit area) within the chamber 110 by controlling the amount of power supplied to the coil 132. For an ICP-RIE process, the first power source 130 may provide an output power ranging from approximately 100 to 125 W.

The second power source 150 (e.g., a 13.56 MHz RF) may be connected to the platen 120 and may serve as a cathode for the system 100 while the chamber walls 112 serve as an anode. The platen (i.e., powered cathode) 120 creates an electric field which accelerates the positive-charged plasma ions towards the platen 120 and towards a sample 10 placed thereon, causing the sample 10 to be bombarded with ions. The second power source 150 controls the bias through which the ions are accelerated (i.e. ion energies). For an ICP-RIE system, the output power of that power source 150 provides an output ranging from approximately 100 to 200 W so as to provide a DC bias in the range of approximately 368 VDC.

With continued reference to FIG. 1, precise amounts of each plasma (measured in standard cubic centimeters per minute (sccm)) may be delivered into the chamber 110 from the plasma source 140 through the feed conduit 142. Process gases may include chlorinated gas (i.e. Cl₂, BCL₃, SiCl₄, etc.) and nitrogen gas, and may also include inert gases such as argon. These gases are introduced into the process chamber 110 in various percentages (in sccm, for example), ranging from approximately 5 to 10 sccm for chlorine, from approximately 5 to 50 sccm for nitrogen, and ranging from approximately 5 to 20 sccm for argon (if provided) (see, e.g., FIG. 7).

As is generally known, the sample 10 may be fabricated using various semiconductor deposition techniques and methods, and may comprise various layers of semiconductor material. In an embodiment of the present invention, the sample 10 is comprised of InP-based semiconductors (e.g., InP, InGaAs, InGaAsP). A dielectric material such as SiO₂ or SiNₓ may be grown atop of the sample 10 top surface and patterned using standard semiconductor lithographic techniques. The patterned dielectric material then serves as a mask for etching into the semiconductor material. The sample 10 is secured to the platen 120, which may be heated by a heating source 160 (e.g., a thermocouple), to a temperature ranging from approximately 150 to 270° C. Using the above-described parameters, etch rates of approximately 600 nm per minute.

In an ICP-RIE system 100 as depicted generally in FIG. 1, and generally as in accordance with embodiments of the present invention, the use of nitrogen gas at a predetermined ratio to chlorine gas dilutes the reactive chlorine gas and promotes sidewall passivation. In addition, selectivity over a silicon dioxide (SiO₂) mask increases proportionately with the amount of nitrogen gas supplied to the plasma chemistry.

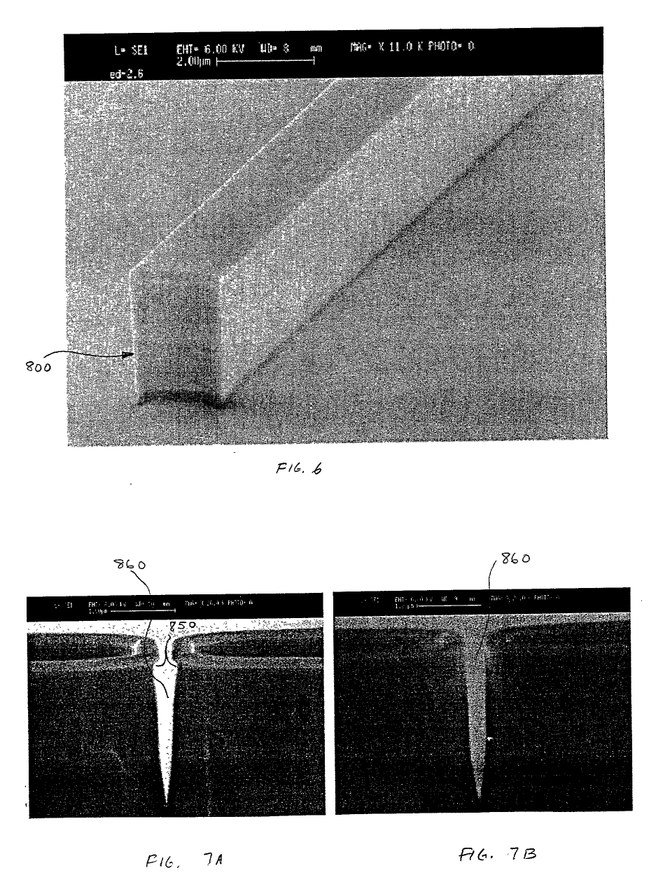

An InP waveguide slab 800, depicted in FIG. 6, was etched using an ICP-RIE process and in accordance with the present invention to a depth of approximately 3.75 μm and at an etch rate of approximately 600 nm per minute. Etched quaternary InGaAsP layers exhibit substantially equivalent surface morphologies (to those depicted in FIG. 6) and any be etched at rates ranging from approximately 80% to 85% of the etch rates achievable for InP. Superior surface smoothness (including the floor) and sidewall verticality (anisotropy) are evident from FIG. 6.

The utilization of nitrogen gas in chlorine-based chemistries may also be used in the fabrication of sub-micron features, such as are depicted in FIGS. 7A and 7B. A lateral notching effect has been observed within sub-micron trenches etched in a chlorinated process. Such notching can be seen in FIG. 7A and is generally designated by reference numeral 850. The use of nitrogen gas at a predetermined ratio to chlorine gas, as provided by the present invention, minimizes notching, as can be seen in FIG. 7B. The ratio of Cl₂:N₂:Ar, with all other process parameters being held constant, was 1:1:1 for FIG. 7A, and 1:2:1 for FIG. 7B. The coupling gap 860 in each of FIGS. 7A and 7B is approximately 250 nm wide.

The smoothness and verticality achievable in accordance with the present invention using an ICP-RIE process are also apparent in FIG. 5, which depicts an annular disc 900 (which may be a resonator) and two generally parallel waveguides 800. Those features were etched with a plasma gas chemistry of Cl₂:N₂:Ar at flow rates of 10 sccm, 35 sccm and 10 sccm, respectively. The first power source 130 was set to provide an ICP power of approximately 200 W, and the second power source 150 was set to provide a power of 100 W. The pressure in the chamber 110 was set to approximately 2.3 mT, and the temperature of the sample 10 was maintained at approximately 250° C. Those parameters yielded an etch rate of approximately 400 nm per minute and provided smooth sidewalls on both the disc 900 and waveguides 800, a smooth bottom surface, and minimal notching effect.

The composition of nitrogen gas needed to preserve anisotropy is dependent on the width of the trench (or coupling gap, as the case may be) between etched features (e.g., waveguides). As the trench width increases, more sever notching may occur so that smaller width trenches require a higher flow rate ratio of N₂ gas to Cl₂ gas. In accordance with this embodiment of the present invention, notching has been minimized in coupling gaps as small as 170 nm wide using a 4:1 ratio of nitrogen gas to chlorine gas.

The smoothness and verticality achievable in accordance with the present invention using an ICP-RIE process are further apparent in FIG. 9, which depicts InP/InGaAsP lithographic alignment marks etched to a depth of approximately 4 mm at an etch rate of approximately 800 nm/min using a Cl₂/N₂/Ar process chemistry in accordance with the present invention.

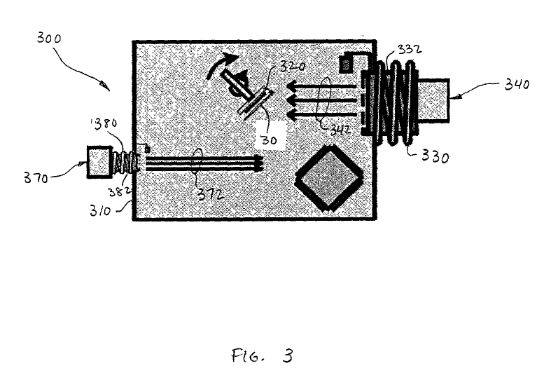

Referring next to FIG. 2, an illustrative ECR-RIE system is there depicted and designated generally as 200. That system 200 includes a chamber 210 within which a sample 20 may be etched by a plasma 60 having a predetermined chemistry, in accordance with the present invention. The sample 20 is selectively placeable on a platen 220, which is coupled to a second power source 250. Plasma gas 60 is introduced into the chamber 210 from a plasma gas source 240, and is accelerated into the chamber by a first power source 230 and an upper solenoid coil 232 that provides an upper magnet. A lower solenoid coil 234 provides a lower magnet. The upper solenoid coil 232 surrounds an applicator discharge zone 236, and the lower solenoid coil 234 is located near the output of the discharge zone 236 and contributes to further plasma confinement and uniformity.

The first power source 230 may be set to provide an ECR power ranging from approximately 100 to 400 W. The second power source 250 maybe selectively set to provide a RF power ranging from approximately 50 to 200 W. Those power setting provide a DC bias in the chamber ranging from approximately 100 to 200 VDC. An upper current into the upper solenoid coil 232 (i.e., upper magnet) of approximately 16 A, and a lower current into the lower solenoid coil 234 (i.e., lower magnet) ranging from approximately 10 to 40 A, provides an appropriately confined and uniform plasma. The temperature of the sample 20 is preferably maintained in the range of approximately 150° to 250° C., and the pressure in the chamber 210 is maintained in the range of approximately 0.64 mT to 2 mT.

Nitrogen gas is provided in the plasma gas at a flow rate ranging from approximately 10 to 20 sccm; while chlorine gas is provided at a flow rate ranging from approximately 3 to 10 sccm.

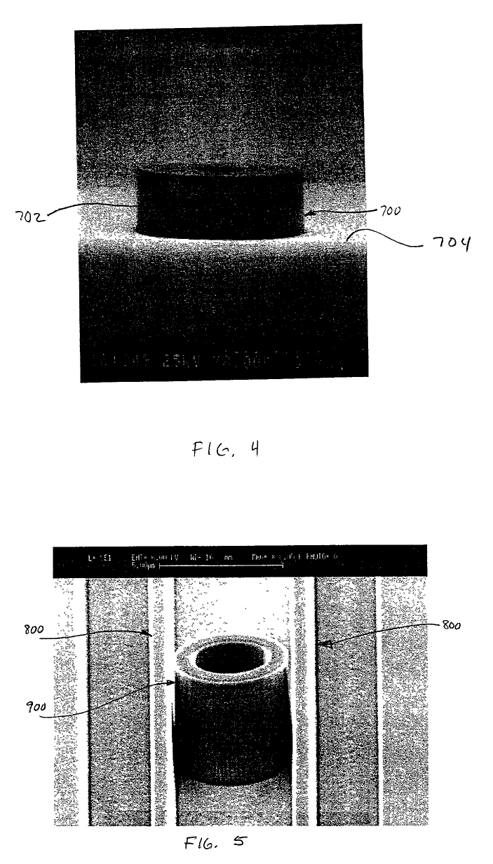

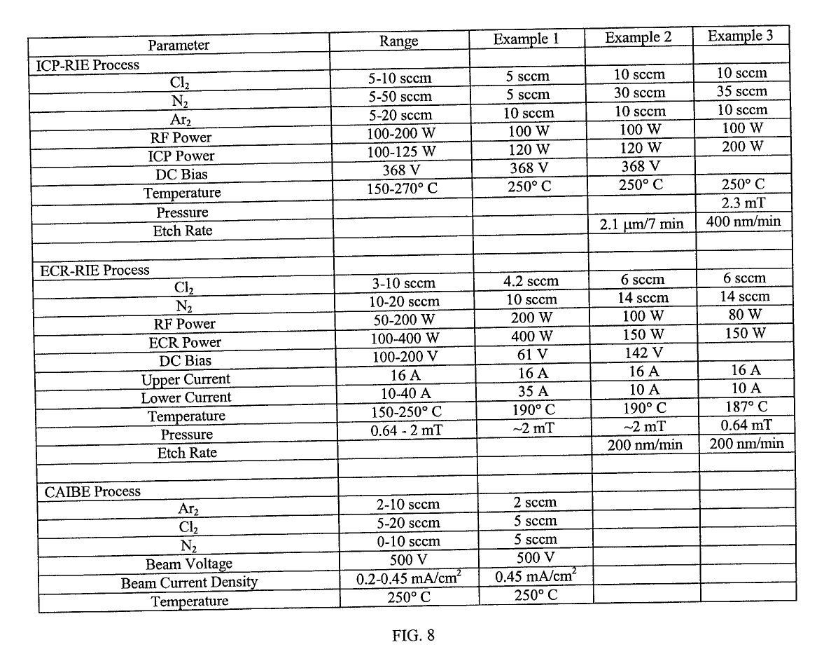

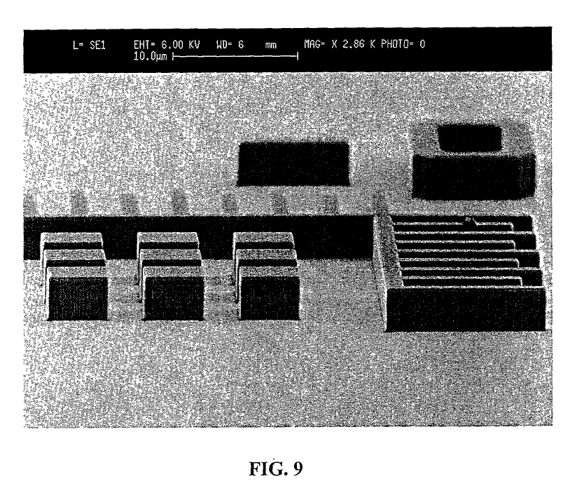

The annular disc 700 depicted in FIG. 4 was etched using an ECR-RIE system 200, as generally depicted in FIG. 2, with etching parameters set as provided in example 3 of the ECR-RIE process of FIG. 8. The smoothness and verticality of the sidewalls 7O2, and smoothness of the bottom surface 704, are readily apparent in FIG. 4.

A general representation of a CAIBE system is depicted in FIG. 3 as reference numeral 300. That system includes a chamber 310 having a reactive gas source 340 (which may comprise one or a plurality of mass flow controllers (MFCs)) fluidly coupled to the chamber 310. A coil 330 is provided about a feed conduit 332 to accelerate the reactive gas 342 from the gas source 340 into the chamber 310. A gas flow rate for Cl₂:N₂:Ar of 5 to 20 sccm, 0 to 10 sccm, and 2 to 10 sccm, respectively, provides the advantageous smooth surface morphology, anisotropy, and etch rates of the present invention. An ion beam source 370 is also fluidly coupled to the chamber 310 via a feed conduit 382 having a coil 380 wound thereabout. The ion beam source 370 generates a collimated ion beam 372. A voltage (i.e., a beam voltage) of approximately 500 V may be applied to the coil 380 to provide a beam current density ranging from approximately 0.2 to 0.45 mA/cm².

A semiconductor sample 30 is selectively placeable on a platen 320 provided in the chamber 310; the platen 320 be selectively movable to control the etching angle of the sample 30. The ions in the collimated beam 372 travel in nearly parallel paths, so the etching proceeds in a “line-of-sight” fashion in the unmasked areas of the sample 30 (i.e., substrate). Control of the etching angle can be achieved by tilting the sample 30 (i.e., tilting the platen 320) with respect to the beam direction. The etching rate and profile can be made insensitive to crystal orientation and alloy composition. The reactive gas 342 adds the benefit of reducing the number of incident ions required to achieve a desired etching depth. This reduces both the amount of ion-induced crystal damage, and undesirable trenching and redeposition effects associated with physical sputtering. Use of the reactive gas also allows one to choose a masking material which does not react with the gas. Deep etches can be made with relatively thin masking layers and little degradation of the mask pattern.

The procedure for positioning a sample 10 and carrying out the method (process) of the present will now be described in detail and with continued reference to FIG. 1. As is generally known, dry etching systems, such as those described herein, typically include a control panel (not shown) which enables setting and control of the various parameters within the etching chamber such as, for example, chamber pressure, platen temperature, power source power (e.g., RF, ICP, and ECR), gas mixture for the plasma gas, and other parameters. Thus, while the following description may not include every step necessary to etch an InP sample 10 in any of an ICP-RIE, ECR-RIE, or CAIBE system, it does include the steps necessary for the present invention.

The InP-based sample 10 may be mounted to a semi-insulating Si wafer (R>5000 Ω/cm⁻¹) (not shown) with Thermalcote II brand thermal paste (not shown). The semi-insulating wafer and sample 10 are placed in a loadlock (not shown) and moved into the chamber 110 by robotics or other automated means provided as part of the system 100. Reference designations are for the ICP-RIE system 100 of FIG. 1 by way of illustration only. It being obvious to persons skilled in the art that the following description applies to each of the dry etch systems depicted in FIGS. 1-3. When bulk-processing 2′-diameter (or larger) InP-based wafers, the wafer need not be mounted to a semi-insulating Si carrier wafer but can be directly transferred into the system chamber and secured to the platen 120.

Process parameters may then be input to the system 100 via an input device such as a keypad or other data entry device (not shown). Exemplary parameters are provided in FIG. 8 and discussed in more detail below.

The present invention was verified by a series of experiments in which the N₂:Cl₂ (and Ar, if provided) gas flow ratio, and other parameters, were varied. For the ICP-RIE process, parameter settings for three examples are provided in FIG. 8. In the first example, the flow rate of N₂:Cl₂:Ar was 5 sccm, 5 sccm and 10 sccm, respectively. The ICP power was set at approximately 120 W, as provided by the first power source 130. The RF power was set at approximately 100 W, as provided by the second power source 150. Those settings provided a DC bias of approximately 368 VDC. The temperature of the sample was maintained at approximately 250° C.

In a second example, the flow rate of N₂:Cl₂:Ar was 30 sccm, 10 sccm and 10 sccm, respectively. The ICP power was set at approximately 120 W, as provided by the first power source 130. The RF power was set at approximately 100 W, as provided by the second power source 150. Those settings provided a DC bias of approximately 368 VDC. The temperature of the sample was maintained at approximately 250°0 C. An etch rate of approximately 2.1 μm per 7 minutes (i.e., 0.3 μm per minute) was achieved.

In a third example, the flow rate of N₂:Cl₂:Ar was 35 sccm, 10 sccm and 10 sccm, respectively. The ICP power was set at approximately 200 W, as provided by the first power source 130. The RF power was set at approximately 100 W, as provided by the second power source 150. The temperature of the sample was maintained at approximately 250° C. An etch rate of approximately 400 nm per minute was achieved.

For the ECR-RIE process, parameter settings for three examples are provided in FIG. 8. In the first example, the flow rate of N₂:Cl₂ was 10 sccm and 4.2 sccm, respectively. The ECR power was set at approximately 400 W, as provided by the first power source 230. The RF power was set at approximately 200 W, as provided by the second power source 250. Those settings provided a DC bias of approximately 61 VDC. An upper bias current of 16 A and a lower bias current of 35 A were also provided. The temperature of the sample was maintained at approximately 190° C., and the pressure was maintained at approximately 2 mT.

In the second example, the flow rate of N₂:Cl₂ was 14 sccm and 6 sccm, respectively. The ECR power was set at approximately 150 W, as provided by the first power source 230. The RF power was set at approximately 100 W, as provided by the second power source 250. Those settings provided a DC bias of approximately 142 VDC. An upper bias current of 16 A and a lower bias current of 10 A were also provided. The temperature of the sample was maintained at approximately 190° C., and the pressure was maintained at approximately 2 mT. Those settings yielded an etch rate of approximately 200 nm per minute.

In the third example, the flow rate of N₂:Cl₂ was 14 sccm and 6 sccm, respectively. The ECR power was set at approximately 150 W, as provided by the first power source 230. The RF power was set at approximately 80 W, as provided by the second power source 250. An upper bias current of 16 A and a lower bias current of 10 A were also provided. The temperature of the sample was maintained at approximately 187° C., and the pressure was maintained at approximately 0.64 mT. Those settings yielded an etch rate of approximately 200 nm per minute.

For the CAIBE process, parameter settings for an example is provided in FIG. 8. In that example, the flow rate of N₂:Cl₂:Ar was 5 sccm, 5 sccm, and 2 sccm, respectively. The beam voltage was set at approximately 500 V, and the beam current density maintained at approximately 0.45 mA/cm². The temperature of the sample was maintained at approximately 250° C.

To overcome the well-known problem of surface roughness due to the low volatility of indium chlorides, Cl₂ gas may be diluted with N₂ to reduce Cl neutral radical density. Using N₂ as a dilute gas showed excellent effect on reaction chemistry in the etching of In-based compound semiconductors.

Gas mixtures mainly used were Cl₂/N₂ and Cl₂/N₂/Ar. The excellent effects of adding N₂ on reaction chemistry in the etching of In-based materials were also observed in ICP-RIE. Compared with ECR-RIE, ICP-RIE has less directionality and ionization efficiency. In order to realize equivalent results, higher bias should be applied. It was found that more than 300 V is necessary to obtain vertical profiles. It is much higher than the optimum voltage of ECR-RIE, which is around 100 V. The high voltage gives rise to surface roughness. At the high voltage, surface roughness was not effectively improved by an increase in N₂/Cl₂ ratio that was an important factor for surface smoothness in ECR-RIE. Mostly, the surface roughness was determined by the applied voltage. To keep the applied voltage low enough for surface smoothness without destroying vertical profiles, higher ICP power was needed. The high ICP power more than 200 W was acceptable for plain waveguide etching. However, it was not desirable for narrow gap etching. In the narrow gap etching, side etching is a fundamental problem. To minimize the side etching, sidewall passivation is required. As observed in ECR-RIE, Nitrogen reacts with In and Ga, and the byproducts passivate the waveguide sidewall. Adding more N₂ in ICP-RIE is conspicuously effective to reduce the side etching.

Thus, while there have been shown and described and pointed out fundamental novel features of the invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It will thus be seen that the objects set forth above, among those made apparent from the preceding description, are efficiently attained and, since certain changes may be made in the above construction without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed is:

1. A process for etching a III-V semiconductor in an ICP-RIE system having a chamber, a first power source to control a plasma density of a plasma, a second power source to control ion energies of the plasma, and a platen for supporting a III-V semiconductor sample inside the chamber, said process comprising the steps of:
(a) placing the sample on the platen;
(b) heating the platen to a temperature ranging from approximately 150° to 270° C.;
(c) introducing reactive source gases into the chamber, said reactive source gases having a predetermined ratio of a nitrogen part and a chlorine part, the nitrogen part being introduced at a volumetric flow rate ranging from approximately 5 to 50 sccm, and the chlorine part being introduced at a volumetric flow rate ranging from approximately 5 to 10 sccm;
(d) setting the power of the first power source to provide a power output of the first power source ranging from approximately 100 to 125 W;
(e) setting the power of the second power source to provide a power output of the second power source ranging from approximately 100 to 200 W; and
(I) etching a feature in a surface of the III-V semiconductor at an etch rate ranging from approximately 0.3 μm per minute to 800 nm per minute.

2. A process as recited by claim 1, wherein the ratio of the nitrogen part to the chlorine part approximately 1:1.

3. A process as recited by claim 1, wherein the ratio of the nitrogen part to the chlorine part approximately 3:1, and wherein the etch rate is approximately 0.3 μm per minute.

4. A process as recited by claim 1, wherein the ratio of the nitrogen part to the chlorine part approximately 3.5:1, the pressure is approximately 2.3 mT, and wherein the etch rate is approximately 400 nm per minute.

5. A process as recited by claim 1, further comprising the step of introducing Argon into the chamber at a volumetric flow rate ranging from approximately 5 to 20 sccm.

6. A process for etching a III-V semiconductor in an ECR-RIE system having a chamber, a first power source to control a plasma density of a plasma, a second power source to control ion energies of the plasma, an upper solenoid coil, a lower solenoid coil, and a platen for supporting a III-V semiconductor sample inside the chamber, said process comprising the steps of:
(a) placing the sample on the platen;
(b) heating the platen to a temperature ranging from approximately 150° to 250° C.;
(c) introducing reactive source gases into the chamber, said reactive source gases having a predetermined ratio of a nitrogen part and a chlorine part, the nitrogen part being introduced at a volumetric flow rate ranging from approximately 10 to 20 sccm, and the chlorine part being introduced at a volumetric flow rate ranging from approximately 3 to 10 sccm;
(d) setting the power of the first power source to provide a power output of the first power source ranging from approximately 50 to 200 W;
(e) setting the power of the second power source to provide a power output of the second power source ranging from approximately 100 to 400 W;
(f) providing an upper current to the upper solenoid coil of approximately 16 A;
(g) providing a lower current to the lower solenoid coil ranging from approximately 10 to 40 A;
(h) providing a pressure in the chamber ranging from approximately 0.64 mT to 2 mT; and
(i) etching a feature in a surface of the III-V semiconductor at an etch rate of approximately 200 nm per minute.

7. A process as recited by claim 6, wherein the ratio of the nitrogen part to the chlorine part approximately 10:4.2, the power output of the first power source is 200 W, the power output of the second power source is 400 W, the lower current is 35 A, and the temperature is 190° C.

8. A process as recited by claim 6, wherein the ratio of the nitrogen part to the chlorine part approximately 7:3, the power output of the first power source is 100 W, the power output of the second power source is 150 W, the lower current is 10 A, the pressure is 2 mT, and the temperature is 190° C.

9. A process as recited by claim 6, wherein the ratio of the nitrogen part to the chlorine part approximately 8:3, the power output of the first power source is 80 W, the power output of the second power source is 150 W, the lower current is 10 A, the pressure is 0.64 mT, and the temperature is 187° C.

10. A process for etching a III-V semiconductor in a CAIBE system having a chamber, a beam voltage source for providing a beam voltage, and a platen for supporting a III-V semiconductor sample inside the chamber, said process comprising the steps of:
(a) placing the sample on the platen;
(b) heating the platen to a temperature of 250° C.;
(c) introducing reactive source gases into the chamber, said reactive source gases having a predetermined ratio of a nitrogen part and a chlorine part, the nitrogen part being introduced at a volumetric flow rate ranging from approximately 0 to 10 sccm, and the chlorine part being introduced at a volumetric flow rate ranging from approximately 5 to 20 sccm;
(d) setting the beam voltage source to provide a beam voltage of approximately 500 V; and (e) providing a beam current density ranging from approximately 0.2 to 0.45 mA/cm².

11. A process as recited by claim 10, wherein the ratio of the nitrogen part to the chlorine part approximately 1:1, and the beam current density is 0.45 mA/cm².

12. A process as recited by claim 10, further comprising the step of introducing Argon into the chamber at a volumetric flow rate ranging from approximately 2 to 10 sccm.

13. A process as recited by claim 11, further comprising the step of introducing Argon into the chamber at a volumetric flow rate ranging of approximately 2 sccm.
